(19) United States
(12) Patent Application Publication
(10) Pub. No.: US 2015/0262146 A1
(43) Pub. Date: Sep. 17, 2015

(54) Gratuity Exchange System

(71) Applicant: Direct Tips, LLC, Douglassville, PA (US)

(72) Inventor: Terence McKim, JR., Douglassville, PA (US)

(73) Assignee: Directs Tips, LLC, Douglassville, PA (US)

(21) Appl. No.: 14/657,152

(22) Filed: Mar. 13, 2015

Related U.S. Application Data
(60) Provisional application No. 61/953,296, filed on Mar. 14, 2014.

(51) Int. Cl. G06Q 20/10

(52) U.S. Cl. CPC G06Q 20/10

(57) ABSTRACT

A system of exchanging value between multiple users is provided. The system includes a value exchange module and a consumer interface module. The value exchange module includes a first account assigned to a first user. The consumer interface module includes a general user interface for a second user and a data input device directly connected to the value exchange module and sending instructions regarding a transfer of a selected gratuity value from a second account linked to the second user and provided through the data input device.

### CROSS-REFERENCE TO RELATED APPLICATIONS

This application is a non-provisional application claiming the benefit of the filing date under 35 U.S.C. §119(e) of Provisional Patent Application No. 61/953,296, filed Mar. 14, 2014.

### FIELD OF THE INVENTION

The invention relates to a gratuity exchange system and, more particularly, to a gratuity exchange system having a gratuity interface module directly connected to a value exchange module.

### BACKGROUND

According to the IRS, a tip is generally defined as: (i) an amount of money presented by a customer free from compulsion; (ii) a payment that the customer has the unrestricted right to determine the amount of; (iii) a payment whose amount cannot be the subject of negotiation or dictated by employer policy; and (iv) generally, a payment in which the customer can dictate and determine the recipient. This gratuity is generally left by the customer for an employee over the amount due for the goods sold or services rendered. According to most state laws, this gratuity belongs to the employee, not to the employer. Generally, when a customer pays the amount due using a credit card, the value charged to the credit card includes a tip. The credit card company typically requires payment of a fee for completing the transaction and that fee is based on the total value of the transaction, which includes the gratuity. Laws provide that the employer must pay the employee the full amount of the tip as indicated by the transaction. Therefore, the employer may not make any deduction from gratuities paid to the employee for credit card processing fees that are charged to the employer by the credit card company. As a result, the employer pays these fees, which can be costly over time.

### SUMMARY

In view of these shortcomings, an object of the invention, among others, is to provide a gratuity exchange system that avoids combining a gratuity with a value of the services rendered.

A system of exchanging value between multiple users is provided. The system includes a value exchange module and a consumer interface module. The value exchange module includes a first account assigned to a first user. The consumer interface module includes a general user interface for a second user and a data input device directly connected to the value exchange module and sending instructions regarding a transfer of a selected gratuity value from a second account linked to the second user and provided through the data input device.

### BRIEF DESCRIPTION OF THE DRAWINGS

Exemplary embodiments of the invention will be described with reference to the accompanying drawings, of which:

FIG. 1 is a schematic diagram of a gratuity exchange system according to the invention;

FIG. 2 is a schematic diagram of a gratuity exchange module according to the invention;

FIG. 3 is a flow diagram of a gratuity exchange system according to the invention;

FIG. 4 is a graphical representation of a consumer interface module according to the invention;

FIG. 5 is another graphical representation of the consumer interface module of FIG. 4;

FIG. 6 is another graphical representation of the consumer interface module of FIG. 4;

FIG. 7 is another graphical representation of the consumer interface module of FIG. 4;

FIG. 8 is screen shot of a consumer interface module according to the invention;

FIG. 9 is another screen shot of a consumer interface module according to the invention; and

FIG. 10 is another screen shot of a consumer interface module according to the invention.

### DETAILED DESCRIPTION OF THE EMBODIMENTS

The invention will now be described in greater detail with reference to the drawings.

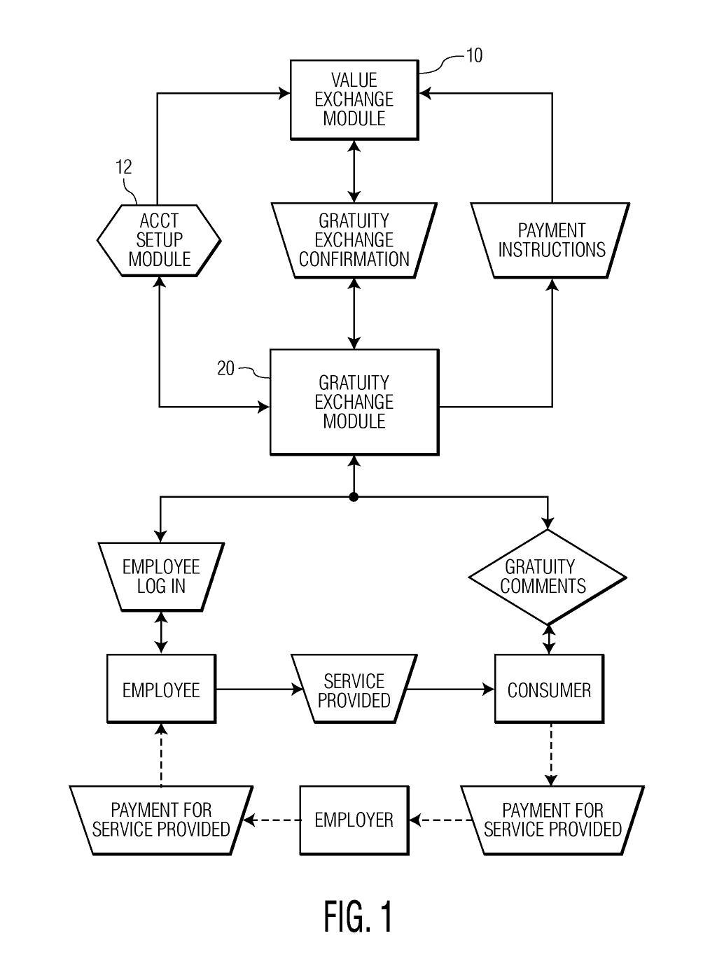

First with reference to FIG. 1, a gratuity exchange system 1 according to the invention is shown and includes two major components. Those major components being a value exchange module 10 and a gratuity exchange module 20 that facilitate user selection and transaction of a gratuity to an employee account using a user-friendly graphical user interface (GUI).

In an exemplary embodiment, the value exchange module 10 includes a processing unit, communication devices and servers, and databases that facilitate a value exchange transaction with a user. The value exchange module 10 may also include a synchronization server for exchanging transaction details with a user device or communication modules and a financial server for interacting with external financial institutions.

In the shown embodiment, a financial account setup module 12 may be included to communicate with the value exchange module 10. The financial account setup module 12 includes a GUI displaying a form and a communication device to connect with the communication server for registering new users. The form includes a request for information necessary to set up a gratuity account with the value exchange module 10. In another embodiment, one skilled in the art should appreciate that the user could use other devices to complete an application using a form, including a writing device and a print of the form.

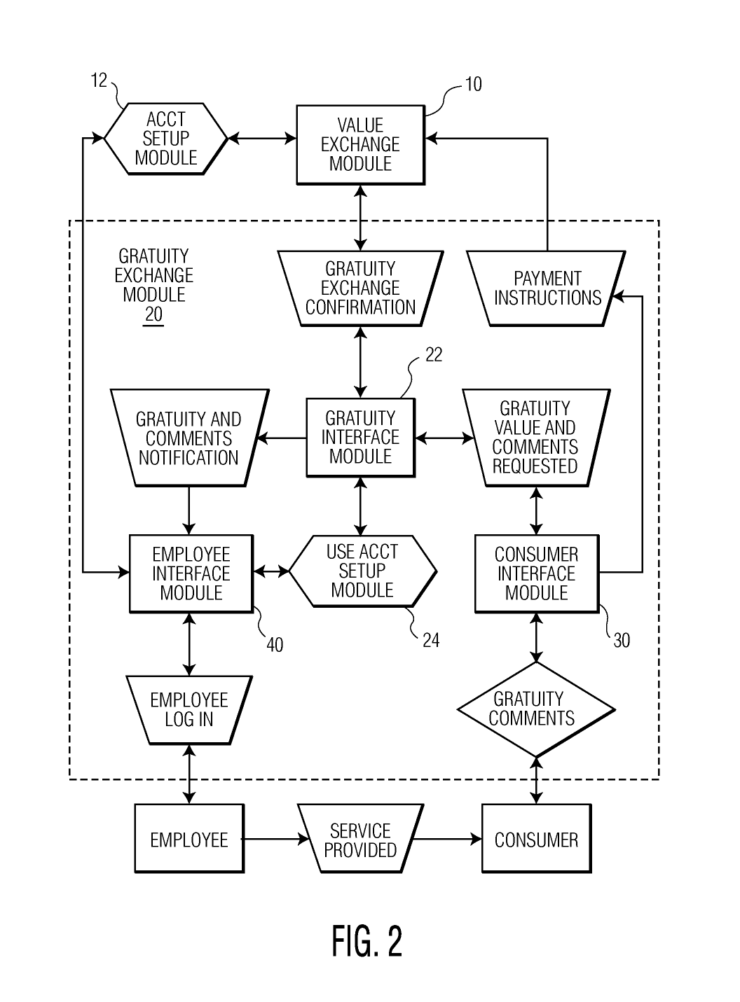

Now with reference to FIG. 2, the gratuity exchange module 20 will be described. The gratuity exchange module 20 includes a gratuity interface module 22, a consumer interface module 30, and an employee interface module 40.

The gratuity interface module 22 is a hub of the gratuity exchange module 20. The gratuity interface module 22 includes a processor, a database, and a communication device.

The processor includes a central processing unit (CPU) that carries out instructions and operations of the gratuity exchange system 1.

The database includes at least a central database, configured to store various information used to facilitate gratuity exchange transactions and data sharing. The information stored in the database may include user accounts, as well as various information pertaining to unregistered users participating in or invited to participate in a transaction, as well as any other data provided by the user or participant. For instance, information stored may include user identifiers (e.g., name, electronic mail address, telephone number, work address, physical address, photos, etc.), transaction records, account balances (e.g., money, store credits, affinity points, vouchers, coupons, discounts), communication methods (e.g., electronic mail, wireless voice), security data, etc.

The communication device and/or other system servers are configured to interact with one or more users through a communication network. For example, the communication device may be or may include a web server, telephone switch, DSLAM (Digital Subscriber Line Access Multiplexer), etc.

In the shown embodiment, the gratuity interface module 22 also includes a user account setup module 24. The user account setup module 24 includes a GUI displaying a form and an interface to connect with the communication module for registering new users. The form includes a request for information necessary to set up a user account with the gratuity exchange module 20. In another embodiment, one skilled in the art should appreciate that the user could use other devices to complete an application using a form, including a writing device and a print of the form.

The consumer interface module 30 is provided to facilitate a one-way transaction between a participant (i.e. consumer) and a registered user of the gratuity exchange module 20.

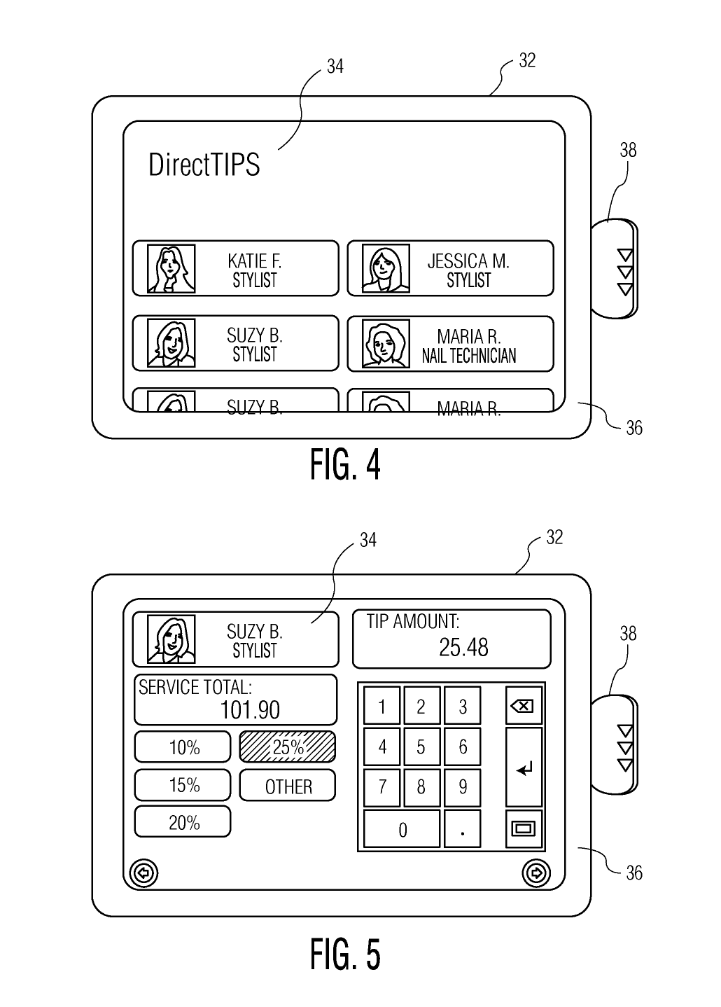

As shown in FIGS. 4-7, an exemplary embodiment of the consumer interface module 30 includes a consumer interaction device 32 having a display for a general user interface 34, a communication device 36, and a data input device 38. The consumer interaction device 32 may be a mobile device, such as a tablet, a notebook computer, or a smart phone. However, one skilled in the art should appreciate that the consumer interaction device 32 may be a stationary device, such as a kiosk or a personal computer. The GUI 34 allows the participant to interact with the consumer interaction device 32 through graphical icons and visual indicators. The communication device 36 is capable of communicating with the gratuity interface module 22 and the value exchange module 10. The data input device 38 in the embodiment shown is a device that reads data from a storage medium. However, it is also possible the data input device 38 is a portal to global e-commerce business allowing payments and money transfers to be made through the Internet. The data input device 38 directly connects to the value exchange module 10 through a consumer communication module.

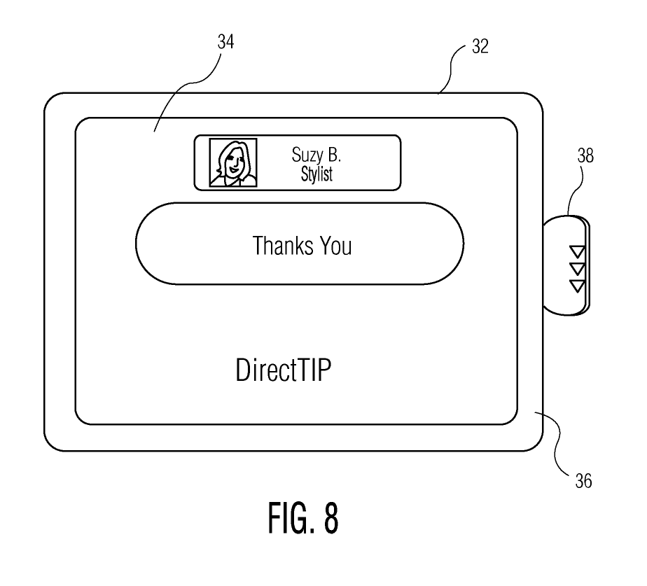

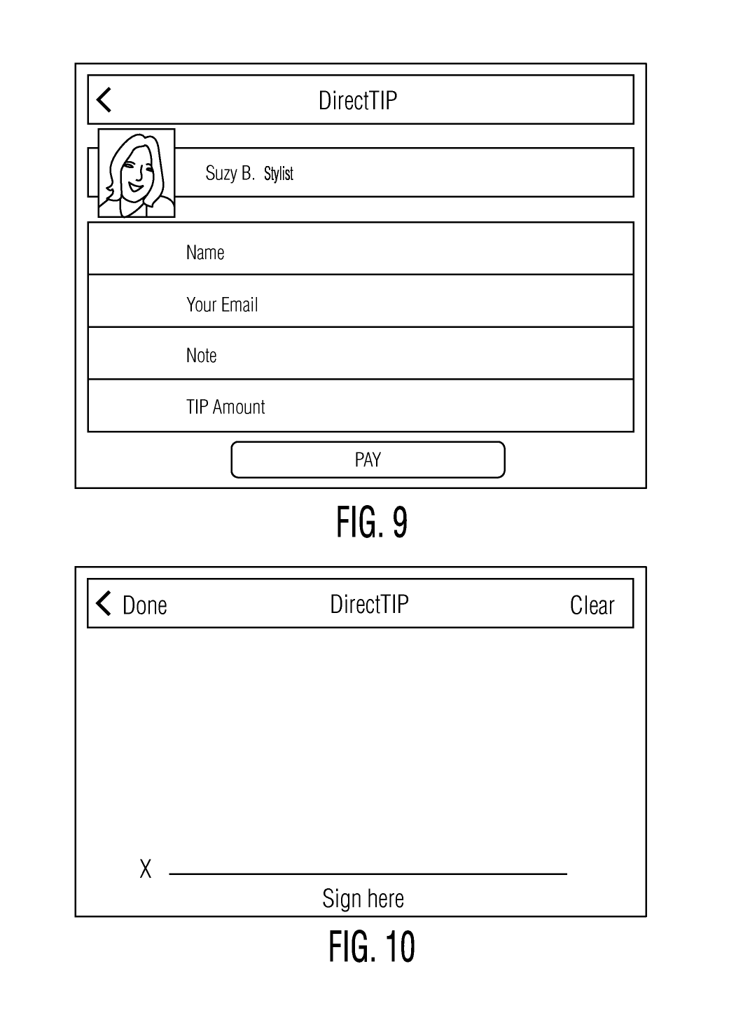

The employee interface module 40 includes a user interaction device having a display for a general user interface and a communication device. Like the consumer interaction device 32, the user interaction device may be a mobile device, such as a tablet, a notebook computer, or a smart phone. However, one skilled in the art should appreciate that the user interaction device may be a stationary device, such as a kiosk or a personal computer displaying the screen shots shown in FIGS. 8 and 9 from a GUI. The GUI allows the user to interact with the consumer interaction device through graphical icons and visual indicators. The communication device is capable of communicating with the gratuity interface module 22.

In another embodiment of the invention, the consumer interface module 30 and the employee interface module 40 share the same interaction devices, such as the consumer interaction device 32 or the user interaction device. The consumer interface module 30 and the employee interface module 40 may share separate GUIs run by separate software, either run through the interaction device or the gratuity interface module 22 using the communication device of the consumer interface module 30.

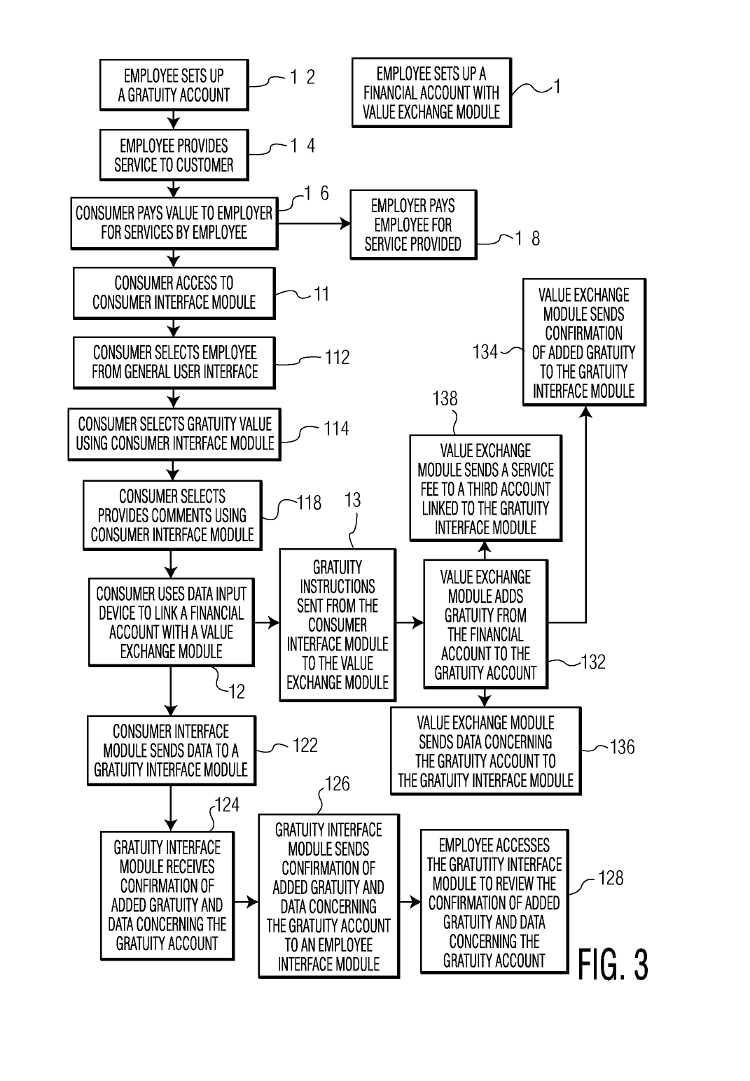

Now, the gratuity exchange system's operation will be described more specifically with reference to FIGS. 3-9.

In an embodiment of the invention, an employee (hired by an employer) sets up a financial account at step 100 through the financial account setup module 12. In addition, the employee at step 102 sets up a gratuity user account, separate from the financial account, with the gratuity interface module 22 using the user account setup module 24. Accordingly, the employee has an exclusive financial account with the value exchange module 10 and a separate exclusive gratuity user account with the gratuity interface module 22.

At step 104, the employee provides a service or good to a consumer who then pays for the service or good to the employer using a payment module. The consumer then pays the employer at step 106, using any known payment means, such as currency, credit or debit cards, coupons, vouchers, etc. In a separate transaction, the employer compensates the employee for his work through payroll at step 108.

Next, the consumer, acting as a participant in the gratuity exchange system 1, accesses the consumer interface module 30 to pay a gratuity to the employee through a separate transaction. In an exemplary embodiment, the consumer is provided the consumer interface module 30 to select a value for the gratuity and to provide any comments to the employee.

At step 110, the consumer selects an employee, who provided them service, from a unique identifier using the GUI screen shown in FIG. 4. In the shown embodiment, the employee is identified by name, photo, and job description. However, one skilled in the art should appreciate that other identifiers are possible, including logos, serial numbers, etc.

Next, the GUI 34 displays the service value of the service or good provided by the employee and paid to the employer. This service value can be auto populated by the gratuity interface module 22, through communication with the payment module. However, it is also possible that the consumer can populate this independently using a numerical keyboard provided through the GUI 34.

At step 114, the consumer then selects a gratuity value though the GUI as shown in FIG. 5. In the shown embodiment, this can be auto populated using the GUI 34 by selecting a percentage of the service value. However, it is also possible that the consumer can independently select the gratuity value using the numerical keyboard provided through the GUI 34.

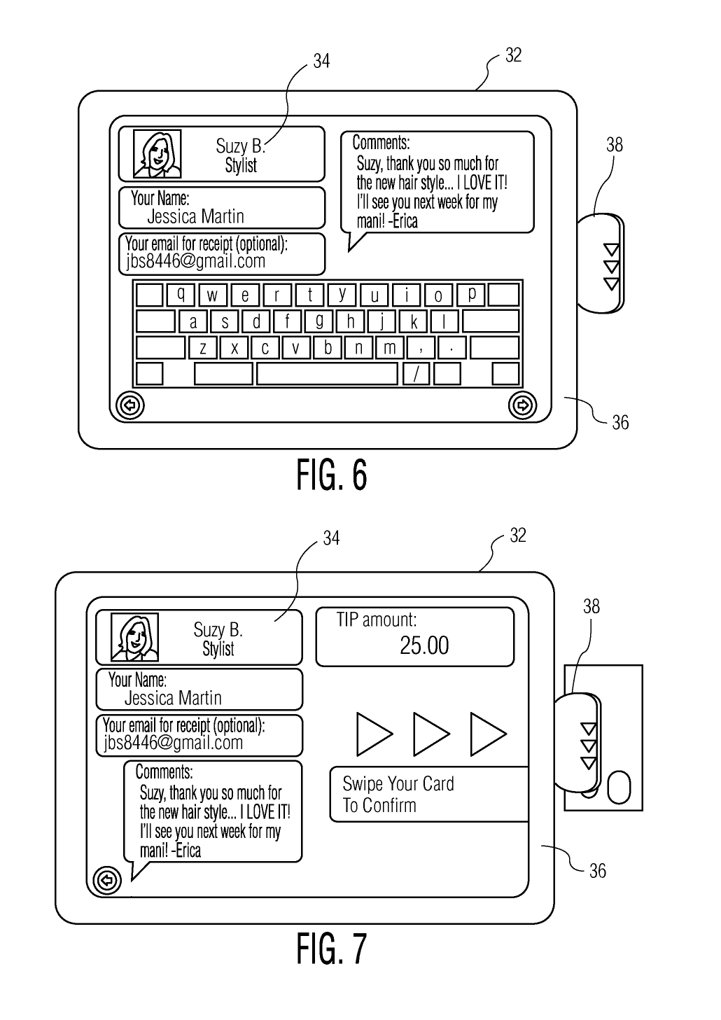

Next, at step 118, the consumer provides other data that the consumer may want to provide the employee, such as name, email address, telephone number, and any comments or notes as shown in the GUI screenshot of FIG. 6. This information can be provided using a keyboard provided through the GUI 34.

At step 120, the consumer provides instruction to deposit a gratuity in the financial account of the employee using the GUI screen shown in FIG. 7. The consumer uses the data input device to indentify information for payment of the selected gratuity value. As shown, a card reader is used to retrieve financial institution information, including bank account and routing information. The consumer interface module 30 communicates directly with the value exchange module 10 without sending information to the gratuity interface module 22, so that no financial institution information is collected by the gratuity interface module 22 databases. In order to initiate the transaction, the consumer may provide a signature, such as handwritten signature or digital signature to secure the transaction (see FIG. 9).

Next, at step 122, the consumer interface module 30 sends information to the gratuity interface module 22, including gratuity value and consumer information, comments, and notes. This data is stored by the gratuity interface module 22.

At step 132, the value exchange module 10 completes a transaction between the consumer's financial account and the financial account setup by the employee through the value exchange module 10. Once completed, the value exchange module 10 sends confirmation of the transaction to the gratuity interface module 22 at step 134. In addition, the value exchange module 10 sends data pertaining to a status of the financial account, including but not limited to the balance, previous transactions, and pending transactions. At step 138, the value exchange module 10 sends a service fee to a service account. This service fee is a proportion of the gratuity value completed during the transaction, and is acquired by owner of the gratuity exchange module 20.

Next, at step 124, the gratuity interface module 22 receives confirmation of the transaction between the consumer's financial account and the financial account and stores the value. In addition, the gratuity interface module 22 receives and stores the status data of the financial account.

At step 126, the employee can access there gratuity account using the employee interface module 40. This can be done by a secure log in. The consumer can then retrieve status data of their financial account and any consumer information, comments, and notes entered and stored through the consumer interface module 30.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A system of exchanging value between multiple users, the system comprising:
a value exchange module having a first account assigned to a first user; and
a consumer interface module having a general user interface for a second user and a data input device directly connected to the value exchange module and sending instructions regarding a transfer of a selected gratuity value from a second account linked to the second user and provided through the data input device.

2. The system of claim 1, wherein the first user is an employee of a third party.

3. The system of claim 2, wherein the first user is separately compensated by the third party for services relating to the selected gratuity value.

4. The system of claim 3, wherein the general user interface displays consideration for the services or goods provided.

5. The system of claim 1, wherein the general user interface displays an identifier of the first user.

6. The system of claim 5, wherein the identifier is a photograph of the first user.

7. The system of claim 6, further comprising a gratuity interface module communicating with the consumer interface module and the value exchange module.

8. The system of claim 7, wherein the gratuity interface module independently receives the data from the consumer interface module and the value exchange module.

9. The system of claim 1, further comprising an employee interface module connected to the consumer interface module and receiving notification data regarding the selected gratuity value exchanged between the value exchange module and the second account.

10. The system of claim 9, further comprising a gratuity interface module communicating with the consumer interface module, the employee interface module, and the value exchange module.

11. The system of claim 10, wherein the gratuity interface module independently sends the data to the employee interface module.

12. A method of facilitating a gratuity exchange between multiple users comprising the steps of:
assigning a first account with a value exchange module for a first user;
receiving instructions to pay a gratuity value from a second user to the first user, the gratuity value relating to a transaction with a third party for services or goods provided by the first user; and
providing an exchange transaction from a financial source of the second user to the first account of the first user who is an employee of the third party.

13. The method of claim 12, further comprising the step of generating a notification of the transaction.

14. The method of claim 13, further comprising the step of electronically sending notification to the second user.

15. The method of claim 11, further comprising the step debiting the gratuity value from a second account of the second user.

16. The method of claim 15, further comprising the step of crediting the gratuity value to the first account.

17. The method of claim 16, further comprising the step of receiving a service fee based on a percentage of the gratuity value.
